(19) United States
(12) Patent Application Publication
(10) Pub. No.: US 2007/0038746 A1
(43) Pub. Date: Feb. 15, 2007

(54) Event management methods and systems

(75) Inventor: Chih Lin Hu, Tainan City (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/502,878

(22) Filed: Aug. 11, 2006

(30) Foreign Application Priority Data
Aug. 12, 2005 (TW) TW94127507

(51) Int. Cl. G06F 15/173

(52) U.S. Cl. 709/224

(57) ABSTRACT

A method for event management. A first subscription request transmitted from a first subscriber apparatus is received, comprising information regarding that the first subscriber apparatus desires to subscribe events published by the service. A first service initiation message is sent in reply to the first subscription request, comprising a group service identification (SID) corresponding to service, a first initial event sequence number, a name of a state variable, and the current value of the state variable. Multiple event messages are repeatedly transmitted, each comprising the group SID corresponding to the service, an event sequence number representing message order, the name of the state variable, and the current value of the state variable.

### BACKGROUND

The present invention relates to event management, and more particularly, to event management methods and systems.

The UPnP framework denotes two device categories, control points (CP) and controlled devices (or simply devices), and six functional layers—addressing, discovering, description, control, eventing and presentation, as listed bottom-up. These layers denote how all UPnP devices behave on a network. Some devices function as servers, offering services monitored and controlled by CPs. A device first acquires an address and then offers a description of its capabilities to the CPs that have discovered it. Once a CP has discovered a device and retrieved descriptions of the device and offered services, the CP is able to either control the device or receive notification events from services. Each UPnP function layer has related network protocols that each device must support.

The eventing layer is briefly described in the following. Eventing allows CPs to monitor state changes in devices. The UPnP architecture uses a publisher/subscriber model whereby CPs may subscribe to a service provided by a device. The device services notify all registered CPs when changes in state variables occur. Responding to state changes in this way enables a UPnP network of devices to be a dynamic, responsive and event-driven system.

The eventing function uses general event notification architecture (GENA) by which subscribers and publishers transfer subscriptions and event notifications. An event is an instance of notification from a service to a subscribed CP and is used to keep the CP informed of state changes associated with the service. A subscription is an established relationship in which a subscriber has indicated interest in receiving a certain notification from a registered publisher. Event messages are sent regardless of the reason for state variable changes, for instance, in response to an action request or an internal state change.

Conventional UPnP eventing functions, however, are not very efficient. Particularly, when multiple CPs subscribe to the same service, they are assigned with different, unique session/subscription identifiers (SIDs). The service maintains a subscriber list. The service updates the subscriber list upon receiving subscription, renewal or cancellation messages from subscribers, and upon forwarding events to subscribers. Once multiple CPs are subscribed to the same service, they are notified of the same state changes, but have different SIDs and event keys. This notification method is referred to as unicasting. Thus, conventional UPnP eventing functions consume excessive resources to maintain subscriber list and SIDs.

### SUMMARY

Methods for event management, performed by a service in a publisher apparatus, are provided. A first subscription request transmitted from a first subscriber apparatus is received. The first subscription request has information regarding that the first subscriber apparatus desires to subscribe events published by the service. A first service initiation message is sent in reply to the first subscription request The first service initiation message has a group service identification (SID) corresponding to the service, a first initial event sequence number, a name of a state variable and the current value of the state variable. Multiple event messages are repeatedly transmitted, each event message has the group SID corresponding to the service, an event sequence number representing message order, the name of the state variable, and the current value of the state variable.

The event sequence number may be incremented before transmission of each event message

An exemplary embodiment of an event management method may further comprise the following steps. It is determined whether the first subscription request is the foremost subscription request for the service, and, if so, the first initial sequence number is set to 0, and otherwise, the first initial sequence number sequence is set to the current event sequence number.

An embodiment of an event management method may further comprise the following steps. A second subscription request transmitted from a second subscriber apparatus is received after receiving the first subscription request, comprising information regarding that the second subscriber apparatus desires to subscribe events published by the service. A second initial sequence number is set to the current event sequence number. A second service initiation message is sent in reply to the second subscription request, comprising the group SID, the second initial sequence number, the name of the state variable and the current value of the state variable.

A record corresponding to the first subscription request may be stored, comprising the group SID, the first initial event sequence number and a callback uniform resource locator (URL) corresponding to the first subscriber apparatus.

A client application in the first subscriber apparatus may acquire service subscription information comprising an event subscription uniform resource locator (URL) corresponding to the service and transmit the first subscription request via the event subscription URL.

A client application in the first subscriber apparatus may receive the first service initiation message and perform an initiation operation according to the current value of the state variable therein. The client application in the first subscriber apparatus may also repeatedly receive the event messages from a network, determine whether each event message comprises the group SID, and, if so, perform subsequent operations according to the content of the event message.

A machine-readable storage medium storing a computer program which, when executed by a subscriber apparatus, performs methods of event management is also disclosed.

Systems for event management are provided. An embodiment of a system for event management comprises a first subscriber apparatus and a publisher apparatus. The publisher apparatus, coupled to the first subscriber apparatus via a network, receives a first subscription request transmitted from a first subscriber apparatus, and replies with a first service initiation message to the first subscription request and repeatedly transmits multiple event messages. The first subscription request comprises information regarding that the first subscriber apparatus desires to subscribe events published by a service. The first service initiation message comprises a group service identification (SID) corresponding to service, a first initial event sequence number, a name of a state variable. The current value of the state variable, and each event message comprises the group SID corresponding to the service, an event sequence number representing message order, the name of the state variable, and the current value of the state variable.

The publisher apparatus may increment the event sequence number before transmitting each event message.

The publisher apparatus may determine whether the first subscription request is the foremost subscription request for the service, and if so, set the first initial sequence number to 0. If not, the first initial sequence number sequence is set to the current event sequence number.

An embodiment of a system for event management may further comprise a second subscriber apparatus coupled to the publisher apparatus via the network. The publisher apparatus receives a second subscription request transmitted from the second subscriber apparatus after receiving the first subscription request, sets a second initial sequence number to the current event sequence number and replies with a second service initiation message to the second subscription request. The second subscription request comprises information regarding that the second subscriber apparatus desires to subscribe events published by the service. The second service initiation message comprises the group SID, the second initial sequence number, the name of the state variable and the current value of the state variable.

The publisher apparatus may store a record corresponding to the first subscription request, comprising the group SID, the first initial event sequence number and a callback uniform resource locator (URL) corresponding to the first subscriber apparatus.

The first subscriber apparatus may acquire service subscription information comprising an event subscription uniform resource locator (URL) corresponding to the service and transmit the first subscription request via the event subscription URL.

The first subscriber apparatus may receive the first service initiation message and perform an initiation operation according to the current value of the state variable therein. The first subscriber apparatus may repeatedly receive the event messages from the network, determine whether each event message comprises the group SID, and, if so, perform subsequent operations according to the content of the event message.

### DESCRIPTION OF THE DRAWINGS

The invention will become more fully understood by referring to the following detailed description of embodiments with reference to the accompanying drawings, wherein:

FIG. 1 is a diagram of network architecture of an embodiment of an event management system;

FIG. 2 is a diagram of a hardware environment applicable to an embodiment of personal computers;

FIG. 3 illustrates a flowchart of an embodiment of a method for event management;

FIG. 4 is a diagram of a storage medium storing a computer program for event management;

FIG. 5 is an exemplary sequence diagram for event management.

### DETAILED DESCRIPTION

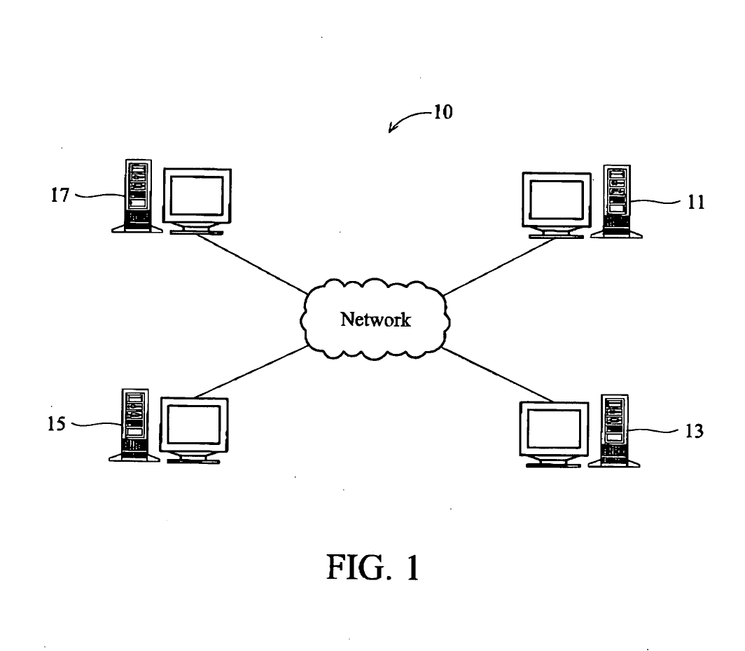

FIG. 1 is a diagram of network architecture of an embodiment of an event management system 10, comprising personal computers 11, 13, 15 and 17. The personal computers 11, 13, 15 and 17 operate in a network using wired, wireless or a combination thereof to connect therebetween. Those skilled in the art will recognize that the personal computers 11, 13, 15 and 17 may be connected in different types of networking environments, and communicate therebetween through various types of transmission devices such as routers, gateways, access points, base station systems or others.

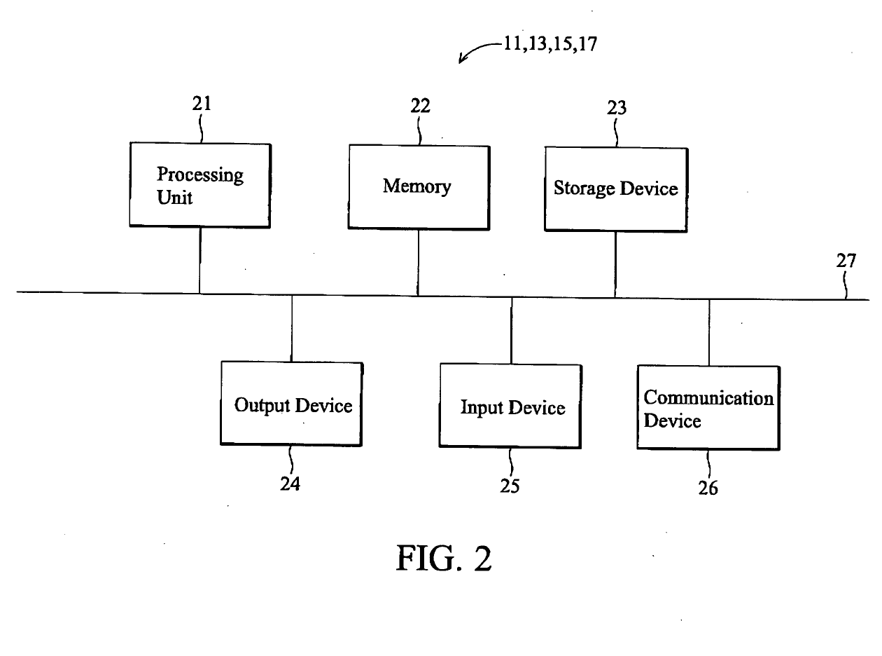

FIG. 2 is a diagram of a hardware environment applicable to an embodiment of the personal computers 11, 13, 15 or 17, comprising a processing unit 21, memory 22, a storage device 23, an output device 24, an input device 25 and a communication device 26. The processing unit 21 is connected by buses 27 to the memory 22, storage device 23, output device 24, input device 25 and communication device 26 based on Von Neumann architecture. There may be one or more processing units 21, such that the processor of the computer comprises a single central processing unit (CPU), a microprocessing unit (MPU) or multiple processing units, commonly referred to as a parallel processing environment. The memory 22 is preferably a random access memory (RAM), but may also include read-only memory (ROM) or flash ROM. The memory 22 preferably stores program modules executed by the processing unit 21 to perform event management functions. Generally, program modules include routines, programs, objects, components, or others, that perform particular tasks or implement particular abstract data types. Moreover, those skilled in the art will understand that some embodiments may be practiced with other computer system configurations, including handheld devices, multiprocessor-based, microprocessor-based or programmable consumer electronics, network PCs, minicomputers, mainframe computers, and the like. The programmable consumer electronics may be mobile stations, projectors, displayers, digital music players, digital video recorders and the like. Some embodiments may also be practiced in distributed computing environments where tasks are performed by remote processing devices linked through a communication network. In a distributed computing environment, program modules may be located in both local and remote memory storage devices based on various remote access architectures such as DCOM, CORBA, Web objects, Web Services or similar. The storage device 23 may be a hard drive, magnetic drive, optical drive, portable drive, or nonvolatile memory drive. The drives and associated computer-readable media thereof (if required) provide nonvolatile storage of computer-readable instructions, data structures and program modules. The communication device 26 may be a wired network adapter or a wireless network adapter compatible with GPRS, 802.x, Bluetooth and the like.

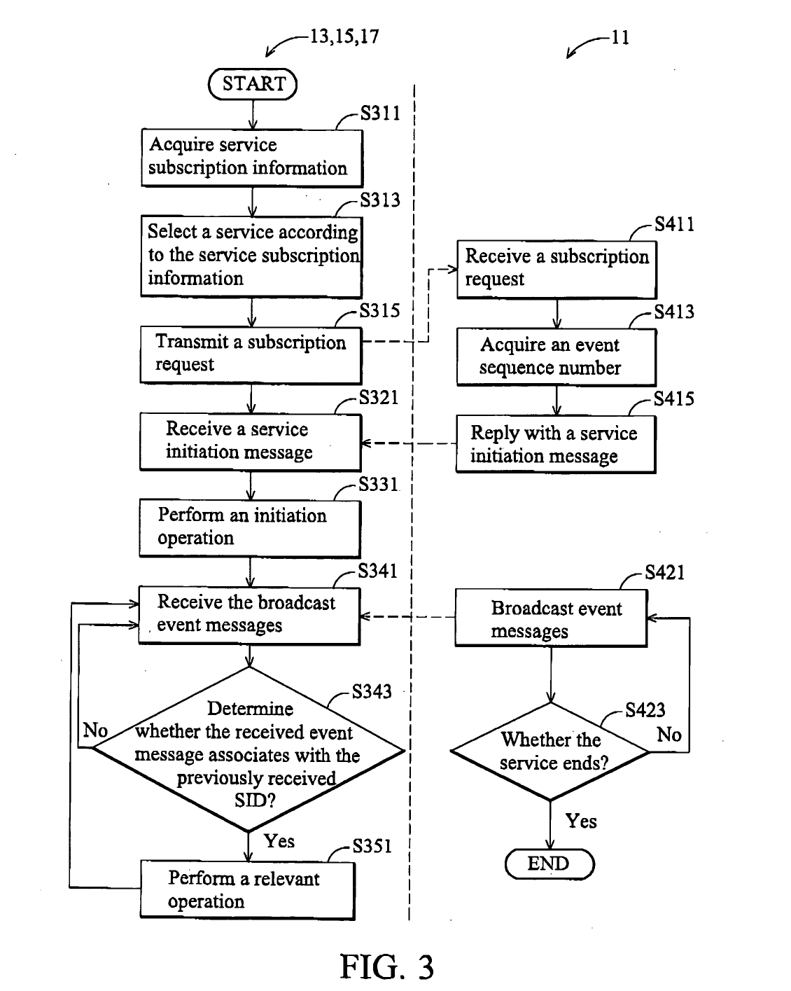

FIG. 3 illustrates a flowchart of an embodiment of a method for event management, divided into two sections, a left section showing steps performed by the personal computers 13, 15 or 17, and a right section showing steps performed by the personal computer 11, separated by dashed lines for added clarity. The personal computer 11, a publisher apparatus, provides services, and the personal computers 13, 15 and 17, subscriber apparatuses, subscribe services provided by the personal computer 11.

In step S311, a client application in a personal computer 13, 15 or 17 acquires service subscription information (referred to as service description in the UPnP specification) regarding a service identifier <SID> and an event subscription uniform resource locator (URL) <eventSubURL> for each service. Client applications, for example, may be network radios receivers, network chatroom clients, web TV receivers, on-line game clients. The service subscription information may be acquired from the computer 11, local storage device or a remote computer located in the network. In step S313, a service is selected according to the service subscription information. Furthermore, a multicast address for the selected service, typically being an address ranging between 239.0.0.0 and 239.255.255.255 reserved for multicasting, may be further determined in step S313. The multicast address for the selected service may be hard-coded in both the service and the client application, described in the service subscription information, or described in a device description. The device description may be acquired from the computer 11, local storage device or a remote computer located in the network. The device description for a device, such as personal computer 11, typically contains several pieces of vendor-specific information, definitions of all embedded devices, URL for presentation of the device, and listings for all services, including URLs for control and eventing. The device description may further be utilized to describe multicast address for services. The details of the device description and the service description may refer to the UPnP specification “UPnP device architecture 1.0 version 1.0.1” established Dec. 2, 2003. In step S315, a subscription request is transmitted to a particular service resident in the personal computer 11 through an event subscription URL of the selected service.

In step S411, the designated service resident in the personal computer 11 receives the subscription request. In step S413, an event sequence number corresponding to the designated service is acquired. The event number, maintained by the designated service, initially starts from zero and increments before publishing an event message, and is subsequently contained in a published event message for message numbering. Note that only a subscriber with foremost subscription to a service will initially receive an event message with an event sequence number “0” and a subscriber followed by the foremost subscriber will initially receive an event message with the current event sequence number. In step S413, the designated service replies with a service initiation message comprising a group SID, the current event sequence number, names of state variables, and current values of state variables corresponding to the designated services. Note that, when several subscribers subscribe to one service, a unique group SID is sent, instead of different group SIDs. In addition, the service initiation message may further comprise a multicast address for the subscribed service. In step S413, a record corresponding to a subscriber request may be stored, comprising a group SID, a callback URL and the current event sequence number, where the callback URL corresponds to a network address of a subscriber.

In step S321, the subscribing client application receives the service initiation message. In step S331, an initiation operation is performed according to the received service initiation message, comprising the group SID, current event sequence number, state variables, current values thereof and the multicast address.

In steps S421 and S423, the designated service resident in the personal computer 11 repeatedly broadcast event messages with the multicast address before the designated service ends, each message comprising the unique group SID, current event sequence number, names of state variables and the current values of state variables. Note that the event sequence number is incremented before each event message is published, other than an initiation message, to maintain the order of event messages.

In step S341, the subscribing client application repeatedly receives the broadcast event messages with the multicast address. In step S343, it is determined whether the received event message associates with the previously received SID, and, if so, the process proceeds to step S351, and otherwise, to step S341. In step S351, a relevant operation is performed contingent upon the content of the received event message. Those skilled in the art will recognize that the relevant operation contains several process logics for the designated specific client application and is briefly described herein.

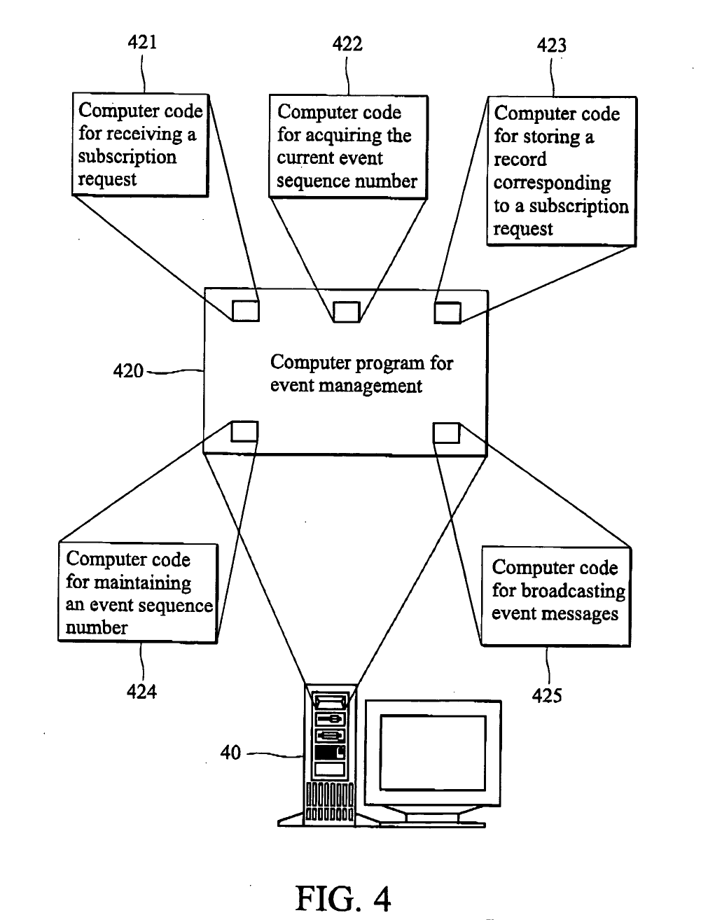

Also disclosed is a storage medium as shown in FIG. 4 storing a computer program 420 providing the disclosed methods of event management. The storage medium 40 includes a computer program having computer readable program code therein for use in a computer system. The computer readable program code comprises at least computer readable program code 421 receiving a subscription request, computer readable program code 422 acquiring the current event sequence number, computer readable program code 423 storing a record corresponding to a subscription request, computer readable program code 424 maintaining an event sequence number, and computer readable program code 425 broadcasting event messages.

Systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system, mobile station, projector, displayer, mp3 player and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

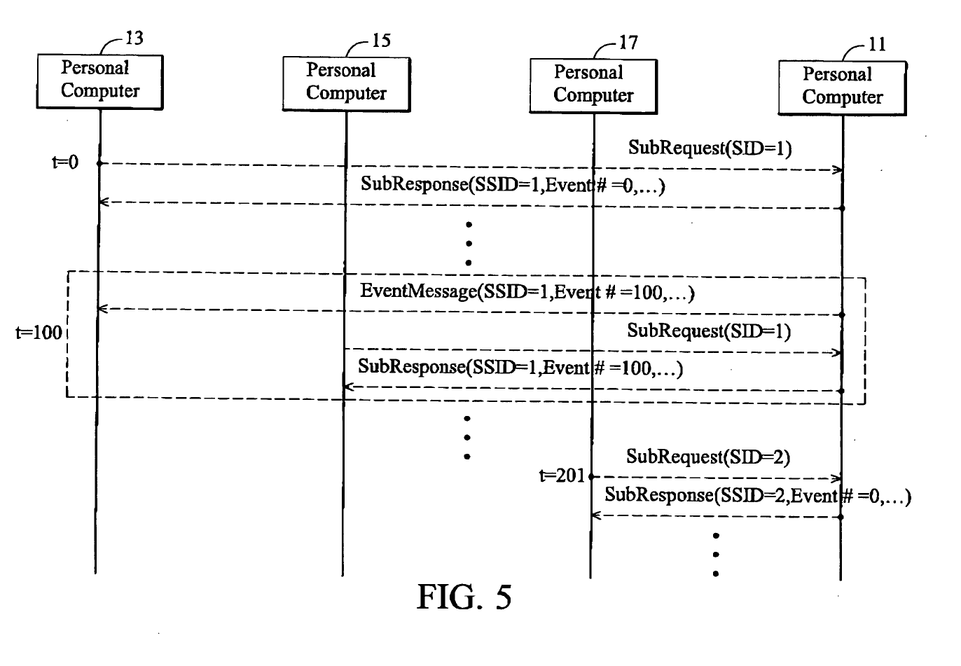

Details of the method for event management are illustrated in the following. FIG. 5 is a diagram of an exemplary sequence for event management. Personal computer 11 operating as a publisher apparatus provides two services respectively with identities, SID=1 and SID=2. Personal computers 13, 15 and 17 operating as subscriber apparatuses subscribe these services.

At t=0, a client application resident in the personal computer 13 transmits a subscription request to a service with an identity (SID=1) resident in the personal computer 11. Because the client application resident in the personal computer 13 is the first subscriber subscribing the service (SID=1), the service (SID=1) replies with an initiation message comprising a group service identity (SSID=1) and an initiated event sequence number (Event#=0). Note that the service (SID=1) begins to maintain the event sequence number of the service (SID=1). Subsequently, the service (SID=1) transmits event messages to the client application resident in the personal computer 13 once that current values of state variables of the service (SID=1) are changed.

At t=100, a client application resident in the personal computer 15 transmits a subscription request to a service with an identity (SID=1) resident in the personal computer 11. Because the client application resident in the personal computer 13 is not the first subscriber subscribing the service (SID=1), the service (SID=1) replies with an initiation message comprising a group service identity (SSID=1) and the current event sequence number (Event#=100). Note that the service (SID=1) begins to maintain the event sequence number of the service (SID=1). Subsequently, the service (SID=1) transmits event messages to the client applications resident in the personal computers 13 and 15 once that current values of state variables of the service (SID=1) are changed.

At t=201, a client application resident in the personal computer 17 transmits a subscription request to a service with an identity (SID=2) resident in the personal computer 11. Because the client application resident in the personal computer 17 is the first subscriber subscribing to the service (SID=2), the service (SID=2) replies with an initiation message comprising a group service identity (SSID=2) and an initiated event sequence number (Event#=0). Note that, because the client application resident in the personal computer 17 subscribes to a service other than that subscribed by the client application resident in the personal computer 13 or 15, the client application resident in the personal computer 17 receives an initiation message comprising the group service identity (SSID=2) other than that received by the personal computer 13 or 15.

While the invention has been described in terms of preferred embodiment, it is not intended to limit the invention to the precise embodiments disclosed herein. Those who are skilled in this technology can still make various alterations and modifications without departing from the scope and spirit of this invention. Therefore, the scope of the invention shall be defined and protected by the following claims and their equivalents.

What is claimed is:

1. A method of event management, performed by a service in a publisher apparatus, comprising:
receiving a first subscription request transmitted from a first subscriber apparatus, the first subscription request comprising information regarding that the first subscriber apparatus desires to subscribe events published by the a service;
replying with a first service initiation message to the first subscription request, the first service initiation message comprising a group service identification (SID) corresponding to the service, a first initial event sequence number, a name of a state variable, and the current value of the state variable: and
repeatedly transmitting a plurality of event messages, each event message comprising the group SID corresponding to the service, an event sequence number representing message order, the name of the state variable, and the current value of the state variable.

2. The method as claimed in claim 1 further comprising incrementing the event sequence number before transmitting each event message.

3. The method as claimed in claim 1 further comprising:
determining whether the first subscription request is the foremost subscription request for the service;
setting the first initial sequence number to 0 when the first subscription request is the foremost subscription request for the service; and
setting the first initial sequence number sequence to the current event sequence number when the first subscription request is not the foremost subscription request for the service.

4. The method as claimed in claim 3 further comprising:
receiving a second subscription request transmitted from a second subscriber apparatus after receiving the first subscription request, the second subscription request comprising information regarding that the second subscriber apparatus desires to subscribe events published by the service;
setting a second initial sequence number to the current event sequence number; and
replying with a second service initiation message to the second subscription request, the second service initiation message comprising the group SID, the second initial sequence number, the name of the state variable and the current value of the state variable.

5. The method as claimed in claim 1 further comprising storing a record corresponding to the first subscription request, the record comprising the group SID, the first initial event sequence number and a callback uniform resource locator (URL) corresponding to the first subscriber apparatus.

6. The method as claimed in claim 1 wherein a client application in the first subscriber apparatus acquires service subscription information comprising an event subscription uniform resource locator (URL) corresponding to the service and transmits the first subscription request via the event subscription URL.

7. The method as claimed in claim 1 wherein a client application in the first subscriber apparatus receives the first service initiation message and performs an initiation operation according to the current value of the state variable therein.

8. The method as claimed in claim 7 wherein the client application in the first subscriber apparatus repeatedly receives the event messages from a network, determines whether each event message comprises the group SID, and, if so, performs subsequent operations according to the content of the event message.

9. The method as claimed in claim 1 wherein a client application in the first subscriber apparatus determines a multicast address for the subscribed events, and listens to the event messages with the multicast address.

10. The method as claimed in claim 9 wherein the multicast address is described in a service description, a device description or the first service initiation message, or hard-coded in the client application.

11. A machine-readable storage medium for storing a computer program which, when executed by a subscriber apparatus, performs a method of event management, the method comprising:
receiving a first subscription request transmitted from a first subscriber apparatus, the first subscription request comprising information regarding that the first subscriber apparatus desires to subscribe events published by the service;
replying with a first service initiation message to the first subscription request, the first service initiation message comprising a group service identification (SID) corresponding to the service, a first initial event sequence number, a name of a state variable, and the current value of the state variable; and
repeatedly transmitting a plurality of event messages, each event message comprising the group SID corresponding to the service, an event sequence number representing message order, the name of the state variable, and the current value of the state variable.

12. A system for event management comprising:
a first subscriber apparatus; and
a publisher apparatus coupled to first subscriber apparatus via a network, receiving a first subscription request transmitted from a first subscriber apparatus, replying with a first service initiation message to the first subscription request and repeatedly transmitting a plurality of event messages,
wherein the first subscription request comprises information regarding that the first subscriber apparatus desires to subscribe events published by a service, the first service initiation message comprises a group service identification (SID) corresponding to service, a first initial event sequence number, a name of a state variable, and the current value of the state variable, and each event message comprises the group SID corresponding to the service, an event sequence number representing message order, the name of the state variable, and the current value of the state variable.

13. The system as claimed in claim 12 wherein the publisher apparatus increments the event sequence number before transmitting each event message.

14. The system as claimed in claim 12 wherein the publisher apparatus determines whether the first subscription request is the foremost subscription request for the service, sets the first initial sequence number to 0 when the first subscription request is the foremost subscription request for the service, and sets the first initial sequence number sequence to the current event sequence number when the first subscription request is not the foremost subscription request for the service.

15. The system as claimed in claim 14 further comprising:
a second subscriber apparatus coupled to the publisher apparatus via the network,
wherein the publisher apparatus receives a second subscription request transmitted from the second subscriber apparatus after receiving the first subscription request, sets a second initial sequence number to the current event sequence number and replies with a second service initiation message to the second subscription request, the second subscription request comprises information regarding the second subscriber apparatus desires to subscribe events published by the service, and, the second service initiation message comprises the group SID, the second initial sequence number, the name of the state variable and the current value of the state variable.

16. The system as claimed in claim 12 wherein the publisher apparatus stores a record corresponding to the first subscription request, and the record comprises the group SID, the first initial event sequence number and a callback uniform resource locator (URL) corresponding to the first subscriber apparatus.

17. The system as claimed in claim 12 wherein the first subscriber apparatus acquires service subscription information comprising an event subscription uniform resource locator (URL) corresponding to the service and transmits the first subscription request via the event subscription URL.

18. The system as claimed in claim 12 wherein the first subscriber apparatus receives the first service initiation message and performs an initiation operation according to the current value of the state variable therein.

19. The system as claimed in claim 18 wherein the first subscriber apparatus repeatedly receives the event messages from the network, determines whether each event message comprises the group SID, and, if so, performs subsequent operations according to the content of the event message.

20. The system as claimed in claim 12 wherein the first subscriber apparatus determines a multicast address for the subscribed events, and listens to the event messages with the multicast address.

21. The system as claimed in claim 20 wherein the multicast address is described in a service description, a device description or the first service initiation message, or hard-coded in the client application.
